(19) United States
(12) Patent Application Publication
(10) Pub. No.: US 2019/0003601 A1
(43) Pub. Date: Jan. 3, 2019

(54) ROTARY VALVE

(71) Applicant: LB Bentley Limited, Stroud Gloucestershire (GB)

(72) Inventor: George Court, Stroud Gloucestershire (GB)

(73) Assignee: LB Bentley Limited, Stroud Gloucestershire (GB)

(21) Appl. No.: 16/066,524

(22) PCT Filed: Oct. 26, 2016
(86) PCT No.: PCT/GB2016/053325

§ 371 Date: Jun. 27, 2018

(30) Foreign Application Priority Data
Jan. 18, 2016 (GB) 1600875.7

(51) Int. Cl. F16K 3/06

(52) U.S. Cl. CPC F16K 3/06

(57) ABSTRACT

A rotary valve is described that includes a rotary valve member including a flow control region, and a valve seat surface with which the flow control region of the valve member is in engagement, a flow port opening into the valve seat surface. The flow port is positioned such that, in a first angular position of the valve member, the flow control region fully closes the flow port and in a second angular position the flow port is just fully unobscured by the flow control region. The first and second angular positions are spaced apart from one another by an angle in excess of 180°.

This invention relates to a rotary valve, and in particular to a rotary gate valve capable of permitting control over the rate of fluid flow through the valve over a wide range of operating pressures and over a wide range of desired flow rates. Whilst the valve may be used in a range of applications, the invention is particularly suitable for use in the injection of chemicals in a controlled fashion to a so-called Christmas tree in the hydrocarbon extraction field of technology.

One form of rotary valve in common use is a rotary gate valve comprising a rotary or angularly moveable valve member including a gate button adapted to engage a sealing surface surrounding a flow port formed in a housing. When the gate button closes the flow port, the valve is closed, flow through the port not being permitted. Angular movement of the valve member from this position allows fluid to flow through the port.

Whilst a valve of this type allows control over whether or not fluid flow is permitted, the relationship between the angle through which the valve member is moved and the rate at which fluid can flow through the port is complex. Furthermore, movement of the valve member between its fully closed and fully open positions occurs over a relatively small angle. As a result, accurate control over the fluid flow rate through the valve is difficult to achieve. Furthermore, it is thought that reliable operation of such a valve over a wide range of operating fluid pressures may be difficult to achieve.

It is an object of the invention to provide a rotary valve in which at least some of the disadvantages associated with known valves are overcome or are of reduced effect.

According to the present invention there is provided a rotary valve comprising a rotary valve member including a flow control region, and a valve seat surface with which the flow control region of the valve member is in engagement, a flow port opening into the valve seat surface, the flow port being positioned such that, in a first angular position of the valve member, the flow control region fully closes the flow port and in a second angular position the flow port is just fully unobscured by the flow control region, the first and second angular positions being spaced apart from one another by an angle in excess of 180°.

Preferably, the first and second angular positions are spaced apart by an angle in the region of 300°.

The relatively large angle of movement of the valve member assists in enabling fine control over the operation of the valve.

The flow port is preferably of tapering width.

The use of a flow port of tapering width allows relatively straightforward control over the flow rate of fluid through the valve.

The flow control region preferably includes a first section of relatively large radius, sufficiently large to allow the flow control region to fully close the flow port when the valve member occupies the first position, a second section of relatively small radius, sufficiently small that the flow port is fully open when the second section is aligned therewith, and an intermediate section in which the radius smoothly varies between the relatively large radius and the relatively small radius.

The flow port is conveniently of triangular shape, orientated such that the base of the triangle is closest to the axis of rotation of the valve member.

The invention further relates to a fluid injection arrangement comprising a rotary valve of the type set out hereinbefore, the rotary valve controlling the flow of fluid between an input line and an output line, a fluid flow rate sensor monitoring the fluid flow rate within the output line, and a control unit operable to compare the fluid flow rate sensed by the sensor with a desired fluid flow rate, and to control the operation of the rotary valve to adjust the angular position of the valve member thereof in the event that there is a difference greater than a predetermined difference between the sensed flow rate and the desired flow rate.

It will be appreciated that the use of the fluid injection arrangement allows accurate control over the injection of fluids into other devices or systems, for example the injection of chemicals into a sub-sea hydrocarbon extraction Christmas tree.

The invention will further be described, by way of example, with reference to the accompanying drawings, in which:

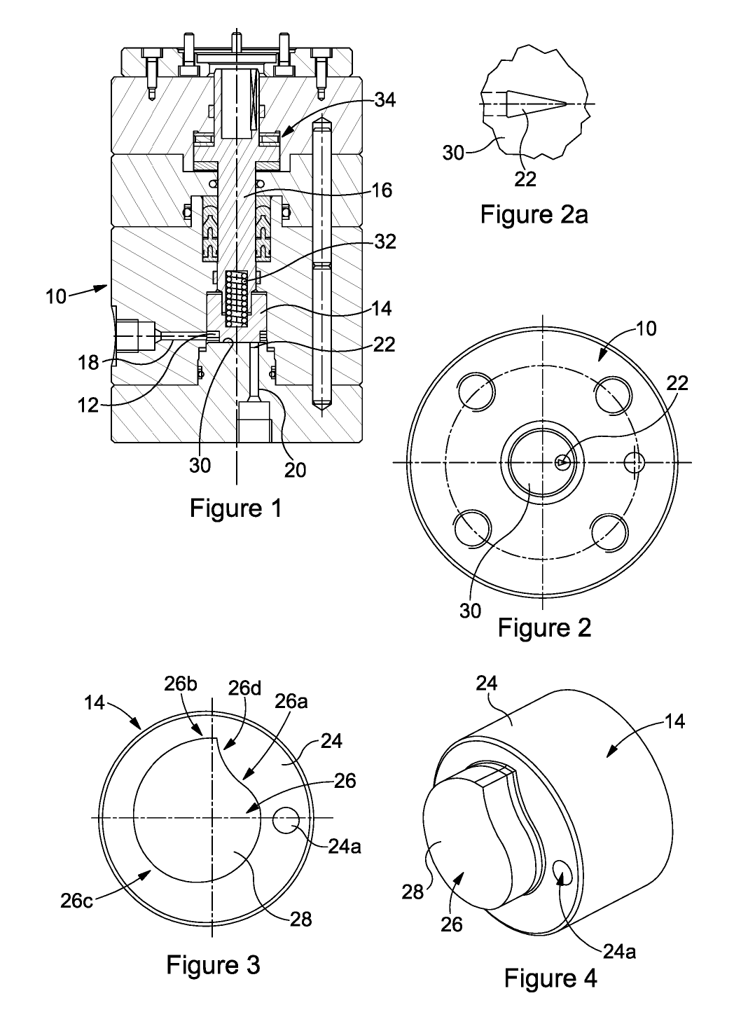

FIG. 1 is a sectional view illustrating a rotary valve in accordance with an embodiment of the invention;

FIG. 2 is a plan view illustrating a part of the valve body of the valve of FIG. 1;

FIG. 2a is an enlarged view illustrating part of the valve body of FIG. 2;

FIGS. 3 and 4 are views illustrating the valve member of the valve of FIG. 1;

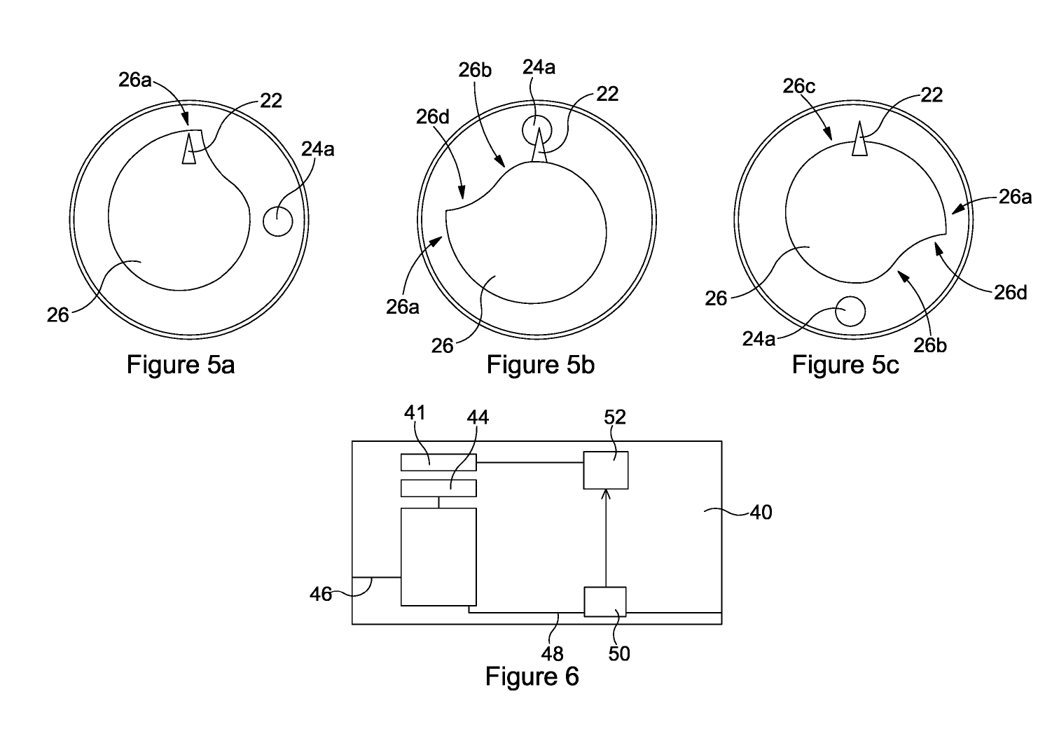

FIGS. 5a, 5b and 5c are diagrammatic views illustrating the valve in a selection of operating conditions; and

FIG. 6 is a diagrammatic representation of a fluid injection apparatus in accordance with another embodiment of the invention.

Referring firstly to FIGS. 1 to 5 of the accompanying drawings, a rotary valve in the form of a rotary gate valve is illustrated that comprises a multi-part housing 10 which defines a chamber 12 within which a rotary valve member 14 is located. The valve member 14 is coupled to a rotatable drive shaft 16 which projects from the valve housing 10, permitting the drive shaft 16 to be coupled to an appropriate actuator (not shown in FIGS. 1 to 5). The actuator may comprise, for example, an electrically controlled motor and an associated gearbox. The motor could take the form of a stepper motor, and the gearbox may take the form of a step-down gearbox. It will be appreciated that such an arrangement may permit very accurate control over the angular position occupied by the drive shaft 16, and hence that of the valve member 14. Whilst the drive shaft 16 may be arranged to be motor driven, other arrangements are possible, for example arrangements in which the position of the drive shaft 16 is manually adjustable.

The housing 10 is provided with an inlet passage 18 which communicates with the chamber 12, and an outlet passage 20 which communicates via a flow port 22 with the chamber 12.

The valve member 14 comprises a body 24 of cylindrical shape, an end of which is provided with an integral projection forming a flow control region 26. The flow control region 26 is shaped to include a first section 26a of relatively large radius, a second section 26b of relatively small radius, and an intermediate section 26c in which the radius of the flow control region 26 gradually increases from the relatively small radius to the relatively large radius. The first, second and third sections 26a, 26b, 26c of the flow control region thus form a spiral-like profile. In the arrangement illustrated, the first section 26a and the second section 26b are angularly spaced apart from one another by an angle in the region of 300°. However, it will be appreciated that this need not be the case, and the invention is applicable to other arrangements in which the angular stroke of the valve member is greater or smaller than this. By way of example, the angular stroke could be as small as, for example, 180°.

The flow control region 26 further includes a fourth section 26d in which the radius rapidly increases from the relatively small radius to the relatively large radius.

The flow control region 26 defines an end face 28 which bears against a seat surface 30 defined by a part of the valve housing 10 into which the flow control port 22 opens. A spring 32 is located between the valve member 14 and the drive shaft 16, applying a biasing load to the valve member 14 ensuring that the end face 28 thereof remains in sealing engagement with the seat surface 30, the biasing load being reacted by appropriate thrust bearings 34 supporting the drive shaft 16. The valve member 14 includes a passage 24a whereby fluid from the chamber 12 can flow to an opposite end of the valve member 14, aiding the spring 32 in maintaining sealing contact between the end face 28 and the seat surface 30.

The location of the point at which the inlet passage 18 opens into the chamber 12 is such that the passage 18 is in constant communication with the chamber 12 regardless as to the angular position of the valve member 14. The position and shape of the flow control port 22 is chosen such that when the valve member 14 occupies a first, closed position, the end face 28 of the valve member 14 fully obscures and closes the flow control port 22. Accordingly, in this position, flow between the inlet passage 18 and the outlet passage 20 is not permitted. This position is shown diagrammatically in FIG. 5a. Furthermore, the shape and position of the flow control port 22 are such that angular movement of the valve member 14 to a second position to angularly align the second section 26b of the flow control region 26 with the flow control port 22 results in the flow control port 22 being fully open, allowing fluid flow between the inlet passage 18 and the outlet passage 20 at a maximum flow rate. In the arrangement illustrated, movement of the valve member 14 between these positions involves rotation of the valve member 14 through approximately 300° as mentioned above. FIG. 5b diagrammatically illustrates the valve as this position is approached. FIG. 5c illustrates the valve at an intermediate position in which the flow control port 22 is only partially obscured by the third section 26c of the flow control region 26, thereby permitting fluid flow between the inlet and outlet passages 18, 20 at an intermediate, restricted rate.

As illustrated, the flow control port 22 is of tapering width, tapering from a maximum width at its base, closest to the axis of rotation of the valve body 14 to a minimum at its apex remote from the axis of rotation of the valve body 14. Specifically, the flow control port 22 is of substantially triangular form. The shapes of the flow control port 22 and the profile of the flow control region 26 are selected so as to achieve a substantially linear relationship between the angular position of the valve body 14 and the flow rate through the valve between the inlet passage 18 and the outlet passage 20. However, it will be appreciated that by modifying the shape of the flow control port 22 and/or the profile of the flow control region 26, other relationships between flow rate and angular position of the valve member 14 may be achieved, if desired.

It will be appreciated that the shape of the flow control region 26 results in the valve member 14 needing to move through a relatively large angle in the region of 300° in order to move from its fully closed position to its fully open position. As a result, fine control over the flow rate through the valve can be achieved with a good degree of accuracy.

The rotary valve described hereinbefore is capable of accurately controlling fluid flow between the inlet and outlet passages 18, 20 thereof over a wide range of flow rates and over a wide range of operating fluid pressures. Accordingly, it will be appreciated that the valve is suitable for use in a wide range of applications.

FIG. 6 illustrates the valve, diagrammatically, in use in a chemical injection apparatus. The apparatus of FIG. 6 comprises a housing 40 containing the rotary valve shown in FIGS. 1 to 5, a drive motor 42, for example in the form of a stepper motor, and a gearbox 44, the motor 42 and gearbox 44 being coupled to the valve in such a manner as to allow the motor 42 to control the angular position occupied by the valve member 14, thus controlling the fluid flow rate between the inlet and outlet passages 18, 20. The inlet passage 18 is connected to a fluid input line 46 whereby chemicals to be injected are supplied to the apparatus. The outlet passage 20 is connected to an output line 48 in which is located a flow meter 50 allowing measurements of the fluid flow rate along the output line 48 to be made. The flow meter 50 is arranged to output fluid flow rate information to a control unit 52, the control unit 52 outputting control signals to the motor 42 to control the position thereof. The output line 48 communicates, via associated valves and connectors (not shown) with a subsea Christmas tree of a hydrocarbon extraction installation to allow the supply of appropriate chemicals thereto, when desired.

In use, with the apparatus connected to a suitable chemical supply and to the Christmas tree, when it is desired to make a chemical injection to the Christmas tree, the control unit 52 controls the motor 42 to move the valve member 14 to a desired open position. The resulting fluid flow rate along the output line 48 is monitored by the flow meter 50, and the control unit 52 compares the measured flow rate with a desired flow rate. If the measured flow rate differs from the desired flow rate by an unacceptably large amount, then the control unit 52 may adjust the motor position to modify the position of the valve member 14 to cause a change in the flow rate through the valve to bring the flow rate to a desired level. It will be appreciated, that the chemical injection apparatus can thus be used to allow the injection of an accurately controlled fluid supply to the Christmas tree.

If, during use, any wear occurs in the profile of flow control port 22, the flow meter 50 and control unit 52 will sense the increase in flow at a given position and make appropriate corrections to the radial position of the flow control region 26 to maintain a desired flow rate.

Conveniently, when the motor 42 drives the valve member 14 for movement, the valve member 14 is only driven in a single direction. As a result, any backlash within the system is taken up prior to the initial movement of the valve member 14 and, thereafter, accurate control over the position of the valve member 14 can be achieved without need to allow for taking up backlash. However, it will be appreciated that this need not always be the case and other modes of operation are possible.

Whilst the chemical injection apparatus described hereinbefore represents one application in which the valve may be employed, it will be appreciated that it may be used in a wide range of other applications.

Although specific embodiments of the invention have been described hereinbefore, it will be appreciated that a wide range of modifications and alterations may be made thereto without departing from the scope of the invention as defined by the appended claims.

1. A rotary valve comprising a rotary valve member including a flow control region, and a valve seat surface with which the flow control region of the valve member is in engagement, a flow port opening into the valve seat surface, the flow port being positioned such that, in a first angular position of the valve member, the flow control region fully closes the flow port and in a second angular position the flow port is just fully unobscured by the flow control region, the first and second angular positions being spaced apart from one another by an angle in excess of 180°.

2. A valve according to claim 1, wherein the first and second angular positions are spaced apart by an angle in the region of 300°.

3. A valve according to claim 1, wherein the flow port is of varying width.

4. A valve according to claim 3, wherein the flow port is of tapering width.

5. A valve according to claim 3, wherein the flow port is of triangular shape, orientated such that the base of the triangle is closest to an axis of rotation of the valve member.

6. A valve according to claim 1, wherein the flow control region includes a first section of relatively large radius, sufficiently large to allow the flow control region to fully close the flow port when the valve member occupies the first position, a second section of relatively small radius, sufficiently small that the flow port is fully open when the second section is aligned therewith, and an intermediate section in which the radius smoothly varies between the relatively large radius and the relatively small radius.

7. A valve according to claim 1, wherein the valve member is arranged to be driven in a single rotary direction.

8. A valve according to claim 1, wherein the valve member is arranged to be driven in both rotary directions.

9. A fluid injection arrangement comprising a rotary valve having a rotary valve member including a flow control region, and a valve seat surface with which the flow control region of the valve member is in engagement, a flow port opening into the valve seat surface, the flow port being positioned such that, in a first angular position of the valve member, the flow control region fully closes the flow port and in a second angular position the flow port is just fully unobscured by the flow control region, the first and second angular positions being spaced apart from one another by an angle in excess of 180°, the rotary valve controlling the flow of fluid between an input line and an output line, a fluid flow rate sensor monitoring the fluid flow rate within the output line, and a control unit operable to compare the fluid flow rate sensed by the sensor with a desired fluid flow rate, and to control the operation of the rotary valve to adjust the angular position of the valve member thereof in the event that there is a difference greater than a predetermined difference between the sensed flow rate and the desired flow rate.
